(19) United States
(12) Patent Application Publication
(10) Pub. No.: US 2008/0062293 A1
(43) Pub. Date: Mar. 13, 2008

(54) Method for multiphase charge transfer in a lamel shutter and apparatus containing such a shutter

(75) Inventors: Adrianus Johannes Mierop, Eindhoven (NL); Paul David Donegan, Kitchener (CA)

Correspondence Address: Daniel E. Fisher, Fisher Technology Law L.L.C, Suite 104, 8221 Old Courthouse Road, Vienna, VA, 22182, US

(73) Assignee: Dalsa Corporation

(21) Appl. No.: 11/517,302

(22) Filed: Sep. 8, 2006

(51) Int. Cl. H04N 3/14; H04N 5/335

(52) U.S. Cl. 348/296

(57) ABSTRACT

A method is described for operating a CMOS sensor array apparatus that has an electronic shutter mechanism with a collective transfer facility for transferring sensed pixel values to an output storage facility, a read facility for time-distributed reading of the transferred pixel values and preparing for a subsequent reset, and a reset facility for collectively resetting array pixels.

In particular, the method operates both the transfer and reset facilities at staggered instants in an operating cycle on mutually exclusive subsets from the pixels.

### BACKGROUND OF THE INVENTION

The invention relates to a method for operating a CMOS sensor array apparatus that has an electronic shutter mechanism with a collective transfer facility for transferring sensed pixel values to an output storage facility, a read facility for time-distributed reading of the transferred pixel values and preparing for a subsequent reset, and a reset facility for collectively resetting array pixels, as recited in the preamble of claim 1. In this application CMOS sensor array apparatus means that the sensor is based on (C)MOS (=Complimentary (Metal Oxide Semiconductor) technology. The latter means that either NMOS transistors are used or PMOS transistors, the former being preferred over the latter, or preferably both, i.e. NMOS and PMOS transistors are used.

Such CMOS sensors have come in broad use. Through separating the transfer and read operations, even fast-moving objects can be detected without spatial distortion of the image. However, in the first place global reset operations, and to a quite somewhat lesser degree global transfer operations will generally represent large capacitive loads. These can create electronic disturbances exerted both on the substrate and also on the power lines. The effect of such disturbances can be a visual artifact in the eventual image, such as represented by an offset shift of the image line or lines that are being processed simultaneously with the global reset, and in particular when the latter turns off. In principle, a complete waveform can be present in the eventual image.

The inventor has recognized that the distributing of the reset over a plurality of partial resets would substantially diminish the electrical interference, without appreciably complicating the overall operation.

### SUMMARY TO THE INVENTION

In consequence, amongst other things, it is an object of the present invention to diminish the electrical interference by distributing of the reset over a plurality of partial resets.

Now therefore, according to one of its aspects, the invention is characterized according to the characterizing part of claim 1. Various solutions would appear feasible, but the preferred implementation can be characterized as a “lamel”-type shutter, wherein the subsets are equal-sized and cover uniform array parts.

According to various preferred embodiments, the array has at least three such subsets, the relative staggering among the subsets is uniform, and the subsets are equal-sized. The combination of the above yields a straightforward layout, but not all of these features need always be combined.

The invention also relates to a CMOS sensor array apparatus that is arranged for implementing the method of claim 1, such as being recited in claim 3. Further advantageous aspects of the invention are recited in further dependent Claims.

### BRIEF DESCRIPTION OF THE DRAWING

These and further features, aspects and advantages of the invention will be discussed more in detail hereinafter with reference to the disclosure of preferred embodiments of the invention, and in particular with reference to the appended Figures that illustrate:

FIG. 1, an elementary block diagram of a CMOS sensor array apparatus with global shutter and its immediate environment;

FIG. 2, a prior art organization of a sensor array;

FIG. 3, an organization where all array operations are scrolled;

FIG. 4, an example organization embodiment of the present invention;

FIG. 5, an electronic pixel cell diagram.

### DETAILED DESCRIPTION OF PREFERRED EMBODIMENTS

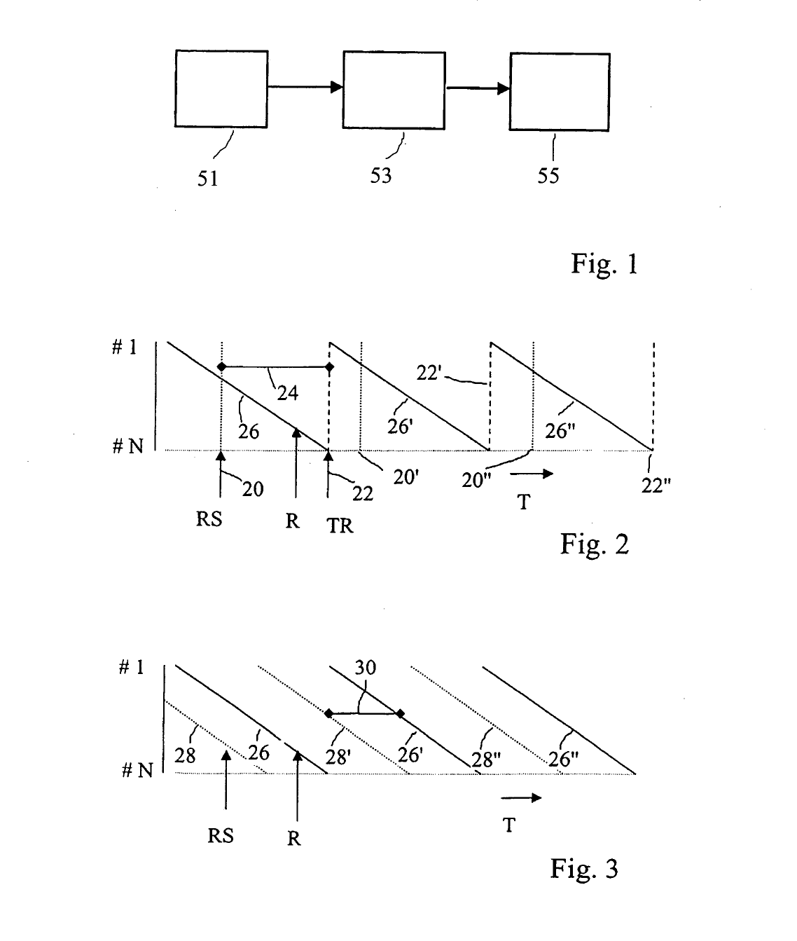

FIG. 1 illustrates an elementary block diagram of a CMOS sensor array apparatus and its immediate environment. In the Figure, item 51 represents a fast moving object, like a soccer player or a bicyclist. Item 53 represents the CMOS sensor with global shutter. Item 55 represents a continuous video stream receiving apparatus, like a television set or a video recorder.

FIG. 2 illustrates a prior art organization of a sensor array. The array lines have been put from top (#1) to bottom (#N) in the picture, whereas time (T) runs from left to right. Generally, the array size is inconsequential, but a million-pixel array has without undue limitation been found feasible. At instant 20, all pixels are reset (RS) in parallel. At instant 22, all accumulated pixel charges are transferred (TR) to an output storage facility. This yields a uniform integration time 24. Next, the pixel storage is read out (R) in a time-distributed manner according to inclined line 26. The cycle is repeated continually, according to reset 20′, 20″, transfer 22′, 22″, and read 26′, 26″. In the electronic circuitry, an additional FET creates possibility for a global shutter operation to avoid disturbances in the capture of fast moving objects. An extra transistor introduced in the pixel circuitry allows for simultaneous exposure control and read-out.

However, image artifacts can be introduced because all pixels are reset globally. This represents a high capacitive load for the clock drivers, which effect can create disturbances on the substrate and also on the power lines during switching. These disturbances can easily affect the video that is currently been sampled and read out. The image artifact is often visible as a shift in offset for the pixel line that is currently been processed when the global reset turns off. A lesser interference is caused by all pixels being also transferred globally.

FIG. 3 illustrates an organization which is based on the scrolling of all array reset operations (RS) 28, 28′, 28″, and reading operations (R) 26, 26′, 26″. In this set-up, the transfer operation (22) of FIG. 2 has been suppressed. Then, due to the extended reading procedure, fast moving objects are liable to be distorted appreciably.

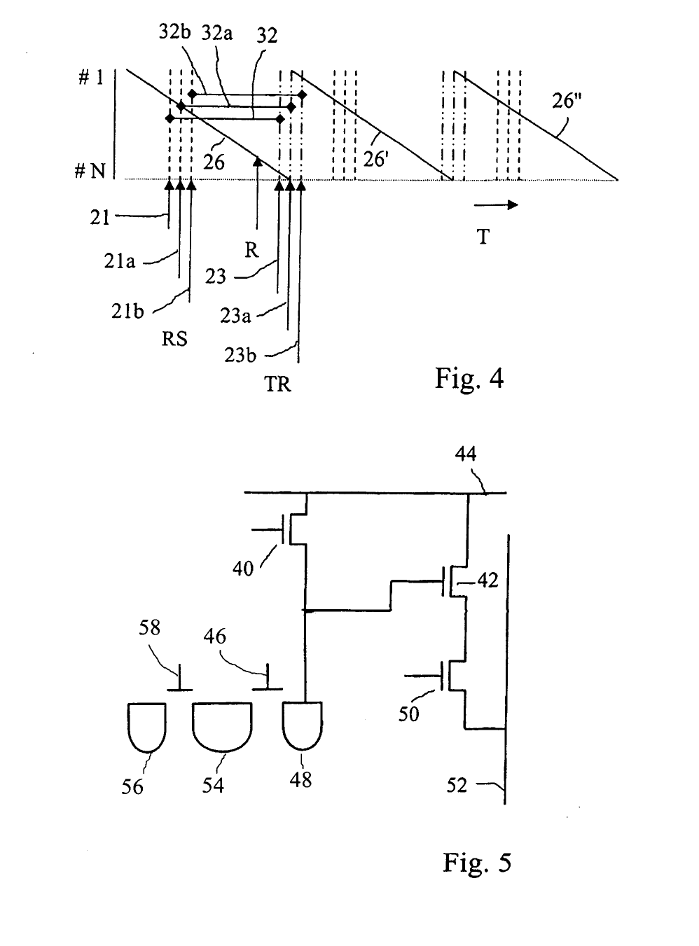

FIG. 4 illustrates an example organization embodiment of the present invention. Herein, to lower the capacitive load on the global reset and transfer lines, a so-called “lamel” shutter is implemented that distributes the power demand over a plurality of lines. This shutter can be visualized as a piecewise rolling shutter, wherein the region or piece that actually contains the shutter operation can be made relatively small.

In particular, read operations (R) 26, 26′ and 26″ are the same as in earlier Figures. Reset (RS) has been divided into three partial resets such as 21, 21a and 21b. Actual reset is effected for lines 1, 4, 7, etc. through partial reset 21, for lines 2, 5, 8, etc. through partial reset 21a, and for lines 3, 6, 9, etc. through partial reset 21b. To each partial reset corresponds a partial transfer 23, 23a and 23b, respectively, so that the integration time lengths, 32, 32a and 32b, remain uniform for all array lines. Admittedly, the actual integration intervals are shifted with regards to each other. However, this interval shift of only a few image lines is much lesser than the interval shift experienced with the completely-rolling shutter of FIG. 3. With line periods of e.g. 20-30 microsecs and 16 subsets the actual integration shift is still less than ½ milliseconds. For most applications, such is completely suitable. Generally, the transfers are staggered too, so that integration times remain uniform. The stagger size can be designed according to needs, but will generally be less or much less than a quarter of the integration time.

Various distributions to the partial resets are feasible, of which only few will be given hereinafter. Thereupon, persons skilled in the art will be able to amend the distribution whilst remaining within the scope of the present invention as claimed. Now, a first organization has the lines distributed according to:

### (1, 2, . . . , N/16), (1+N/16, 2+N/16, . . . , 2N/16), (1+2N/16, 2+2N/16, . . . , 3N/16), . . .

The first two examples can be combined according to:

### (1, 2, 1+N/16, 2+N/16, 1+2N/16, 2+2N/16, . . . ), (3, 4, 3+N/16, 4+N/16, 3+2N/16, . . . ). (5, 6, . . .

If the system would thereby remain within temporal restrictions, even a slight deviation from uniformity among the various subgroups could be allowable.

FIG. 5 by way of illustration shows an electronic pixel cell diagram. Here, sensitive node 54 accumulates the electric charge, transfer node 46 will effect charge transfer to detection node 48, and source follower node 42 and selection node 50 will present the transferred charge to output node 52. Supplementarily, node 44 carries a reference voltage, and node 40 will effectuate the reset operation. An extra transistor introduced in the pixel circuitry allows for simultaneous exposure control and read-out. Said transistor comprises global reset gate 58 and reference node 56.

Now, the present invention has hereabove been disclosed with reference to preferred embodiments thereof. Persons skilled in the art will recognize that numerous modifications and changes may be made thereto without exceeding the scope of the appended Claims. In particular, various configurations for the staggered transferring and resetting are feasible, such as through manipulating the sequence orders among the subsets of lines, the sizes of the subsets themselves, and various other permutations. Although the invention is particular suitable for recording sport events, like soccer games or bicyclist events, other applications in which fast moving objects occur may be envisaged. In consequence, the embodiments should be considered as being illustrative, and no restriction should be construed from those embodiments, other than as have been recited in the Claims.

1. A method for operating a CMOS sensor array apparatus that has an electronic shutter mechanism with a collective transfer facility for transferring sensed pixel values to an output storage facility, a read facility for time-distributed reading of the transferred pixel values and preparing for a subsequent reset, and a reset facility for collectively resetting array pixels,
said method being characterized by operating said transfer and reset facilities at staggered instants in an operating cycle on mutually exclusive subsets from the pixels.

2. A method according to claim 1 whilst maintaining a substantially uniform sensing integration time among the pixels.

3. A CMOS sensor array apparatus arranged for implementing the method of claim 1, being provided with an electronic shutter mechanism provided with a collective transfer facility for transferring sensed pixel values to an output storage facility, a read facility for time-distributed reading of the transferred pixel values and preparing for a subsequent reset, and a reset facility for collectively resetting array pixels,
characterized in that said reset and transfer facilities are arranged for operating at staggered instants in an operating cycle on mutually exclusive subsets from the pixels.

4. An apparatus as claimed in claim 3, that maintains a substantially uniform sensing integration time among the pixels.

5. An apparatus as claimed in claim 3, and operating with at least three such subsets.

6. An apparatus as claimed in claim 3, wherein the relative staggering among such subsets is uniform.

7. An apparatus as claimed in claim 3, wherein the subsets are equal-sized.

8. An apparatus as claimed in claim 3, wherein the relative staggering among such subsets is uniform and less than a quarter of the integration time.
